(19) United States
(12) Patent Application Publication
(10) Pub. No.: US 2024/0220211 A1
(43) Pub. Date: Jul. 4, 2024

(54) SYSTEM AND METHOD FOR GENERATING CUSTOM FIELDS IN A DATABASE ENTITY

(71) Applicant: RAKUTEN SYMPHONY SINGAPORE PTE. LTD., Singapore (SG)

(72) Inventors: Yogesh CHOUHAN, Indore (IN); Prateek CHOUHAN, Indore (IN); Rohit GUPTA, Indore (IN)

(73) Assignee: RAKUTEN SYMPHONY SINGAPORE PTE. LTD., Singapore (SG)

(21) Appl. No.: 17/918,742

(22) PCT Filed: May 18, 2022
(86) PCT No.: PCT/US2022/029770

§ 371 Date: Oct. 13, 2022

(51) Int. Cl. G06F 8/34; G06F 8/38; G06F 16/21; G06F 16/25

(52) U.S. Cl. CPC G06F 8/34; G06F 8/38; G06F 16/213; G06F 16/252

(57) ABSTRACT

A method, performed by at least one processor, for adding user-defined custom fields to a user interface (UI) view of a previously-developed application, includes: outputting a first screen for creating or editing a UI view of the previously-developed application; receiving a user selection to add a new user input field to the UI view; and storing one or more parameters of the new user input field in association with a reserved field of a reserved database of the previously-developed application, such that values input to the new user input field during execution of the user interface view are saved to the reserved field. The previously-developed application includes a plurality of predefined user input fields predefined during application development, a corresponding plurality of predefined database fields mapped thereto, and the reserved database comprising a predetermined number of reserved fields for mapping to new user input fields added post-development.

### BACKGROUND

Databases may be used in a variety of applications. For example, in business environments, databases may be used to store and manage job information, employee information, site information, and related items for an application.

Typically, a database is managed by a development team or individuals with specialized expertise such that an end user does not have access to add additional fields to the database. To this end, the database fields for an application are previously generated and defined at the time of the application's development. If the end user wants to make updates or any changes to the application that require additional fields in the backend database, the end user must request that the development team add the fields into the database or the end user may have to wait for the development team to add fields to the database when the development team plans a scheduled update over time. This tedious process is time consuming and results in production and financial inefficiencies.

In a related art database, if the end user wishes to add additional fields to the database, the end user must request such addition from the development team or dedicated expert. That is, in the related art, the end user does not have the ability to add new fields to the database at the user interface level or on the fly. The user must request additional fields to be added or updated by a development team dedicated to adding new fields.

### SUMMARY

According to embodiments, systems and methods are provided that allow for an end user to add custom fields to an application and an associated database entity on the fly.

According to embodiments, system and methods are provided to output a user interface (UI) to an end user to allow the end user to add custom fields to one or more reference levels within a database entity. As a result, the end user can add new fields into a database or modified previously added fields in the database on the fly.

According to embodiments, a method, performed by at least one processor, for adding user-defined custom fields to a user interface (UI) view of a previously-developed application, includes: outputting a first screen for creating or editing a UI view of the previously-developed application; receiving a user selection to add a new user field to the UI view; and storing one or more parameters of the new user input field in association with a reserved field of a reserved database of the previously-developed application, such that values input to the new user input field during execution of the user interface view are saved to the reserved field, wherein the previously-developed application comprises a plurality of predefined user input fields predefined during application development, a corresponding plurality of predefined database fields mapped thereto, and the reserved database comprising a predetermined number of reserved fields for mapping to new user input fields added post-development.

The receiving the user selection to add a new user input field to the UI view may comprise receiving a user input of a field type, from among a plurality of predetermined field types, for the new user input field.

The plurality of predetermined field types may comprise a text field type, a number field type, a dropdown field type, and a radio button field type.

The received user input may be a drag-and-drop user input in which a graphical user interface (GUI) object corresponding to the field type is dragged from a list of the plurality of predetermined filed types to an editable display area for defining user input fields of the UI view.

The stored one or more parameters may comprise the field type, and the stored one or more parameters are stored in association with the reserved field at an application level.

The method may further include receiving a user input selecting a resource level, from among a plurality of predetermined resource levels, for the new user input field, wherein the application comprises a plurality of predetermined reserved databases respectively corresponding to the plurality of predetermined resource levels, each of the plurality of predetermined reserved databases comprising a predetermined number of reserved fields.

The method may further include receiving a user input defining a label for the new user input field, wherein the label is saved in association with the new user input field at a view level, such that different labels may be defined for the new user input field in different views.

The method may further include outputting a list of previously-created customer user input fields, stored in association with corresponding reserved fields in the reserved database, selectable by a user to add to the UI view.

According to embodiments, an apparatus for adding user-defined custom fields to a user interface (UI) view of a previously-developed application, includes: a memory storing instructions; and at least one processor configured to execute the instructions to: output a first screen for creating or editing a UI view of the previously-developed application; receive a user selection to add a new user field to the UI view; and store one or more parameters of the new user input field in association with a reserved field of a reserved database of the previously-developed application, such that values input to the new user input field during execution of the user interface view are saved to the reserved field, wherein the previously-developed application comprises a plurality of predefined user input fields predefined during application development, a corresponding plurality of predefined database fields mapped thereto, and the reserved database comprising a predetermined number of reserved fields for mapping to new user input fields added post-development.

The at least one processor may be further configured to execute the instructions to receive a user input of a field type, from among a plurality of predetermined field types, for the new user input field.

The plurality of predetermined field types may comprise a text field type, a number field type, a dropdown field type, and a radio button field type.

The received user input may be a drag-and-drop user input in which a graphical user interface (GUI) object corresponding to the field type is dragged from a list of the plurality of predetermined filed types to an editable display area for defining user input fields of the UI view.

The stored one or more parameters may comprise the field type, and the stored one or more parameters are stored in association with the reserved field at an application level.

The at least one processor is further configured to execute the instructions to receive a user input selecting a resource level, from among a plurality of predetermined resource levels, for the new user input field, wherein the application comprises a plurality of predetermined reserved databases respectively corresponding to the plurality of predetermined resource levels, each of the plurality of predetermined reserved databases comprising a predetermined number of reserved fields.

The at least one processor is further configured to execute the instructions to receive a user input defining a label for the new user input field, wherein the label is saved in association with the new user input field at a view level, such that different labels may be defined for the new user input field in different views.

The at least one processor is further configured to execute the instructions to output a list of previously-created customer user input fields, stored in association with corresponding reserved fields in the reserved database, selectable by a user to add to the UI view.

According to embodiments, a non-transitory computer-readable recording medium has recorded thereon instructions executable by at least one processor to perform a method for adding user-defined custom fields to a user interface (UI) view of a previously-developed application, the method including: outputting a first screen for creating or editing a UI view of the previously-developed application; receiving a user selection to add a new user field to the UI view; and storing one or more parameters of the new user input field in association with a reserved field of a reserved database of the previously-developed application, such that values input to the new user input field during execution of the user interface view are saved to the reserved field, wherein the previously-developed application comprises a plurality of predefined user input fields predefined during application development, a corresponding plurality of predefined database fields mapped thereto, and the reserved database comprising a predetermined number of reserved fields for mapping to new user input fields added post-development.

The receiving the user selection to add a new user input field to the UI view may include receiving a user input of a field type, from among a plurality of predetermined field types, for the new user input field.

### BRIEF DESCRIPTION OF THE DRAWINGS

Features, advantages, and significance of exemplary embodiments of the disclosure will be described below with reference to the accompanying drawings, in which the signs denote like elements, and wherein:

FIG. 1 is a flowchart of an example process for adding user-defined custom fields to a user interface (UI) view of a previously-developed application, according to an example embodiment;

FIG. 2 is a diagram of an example environment in which systems and/or methods, described herein, may be implemented;

FIG. 3 is a diagram of example components of a device according to an embodiment;

FIG. 4 is a flowchart of an example process for adding user-defined custom fields to a user interface (UI) view of a previously-developed application, according to an example embodiment;

FIG. 5 is a flowchart of an example process for adding user-defined custom fields to a user interface (UI) view of a previously-developed application, according to an example embodiment;

FIG. 6 is a flowchart of an example process for adding user-defined custom fields to a user interface (UI) view of a previously-developed application, according to an example embodiment;

FIG. 7 illustrates an example graphical user interface (GUI) screen for the dragging-and-dropping a user field input in an editable view of the user interface (UI) screen; and

FIG. 8 illustrates an example UI screen for selecting a resource level and displaying a quantity of occupied reserved fields at the resource level.

### DETAILED DESCRIPTION OF THE INVENTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiments may be incorporated into or combined with another embodiments (or one or more features of another embodiment). Additionally, in the flowcharts and descriptions of operations provided below, it is understood that one or more operations may be omitted, one or more operations may be added, one or more operations may be performed simultaneously (at least in part), and that order of one or more operations may be switched.

It will be apparent that systems and/or methods, described herein, may be implemented in different forms of hardware, firmware, or a combination of hardware and software. The actual specialized control hardware or software code used to implements these systems and/or methods is not limiting of the implementations. Thus, the operation and behavior of the systems and/or methods were described herein without reference to specific software code. It is understood that software and hardware may be designed to implement the systems and/or methods based on the description herein.

As is traditional in the field, embodiments may be described and illustrated in terms of blocks which carry out a described function or functions. These blocks, which may be referred to herein as units or modules or the like, may be physically implemented by analog or digital circuits such as logic gates, integrated circuits, microprocessors, microcontrollers, memory circuits, passive electronic components, active electronic components, optical components, hardwired circuits, or the like, and may be driven by firmware and software. The circuits may, for example, be embodied in one or more semiconductor chips, or on substrate supports such as printed circuit boards and the like. Circuits included in a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks. Likewise, the blocks of the embodiments may be physically combined into more complex blocks.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Example embodiments of the present disclosure provide a method and system in which an end user can generate custom fields in a database entity. As a result, time and cost inefficiencies can be reduced by needing to contact the development team. Further, by directly allowing the end user to add custom fields to the database, the end user can perform on the fly changes.

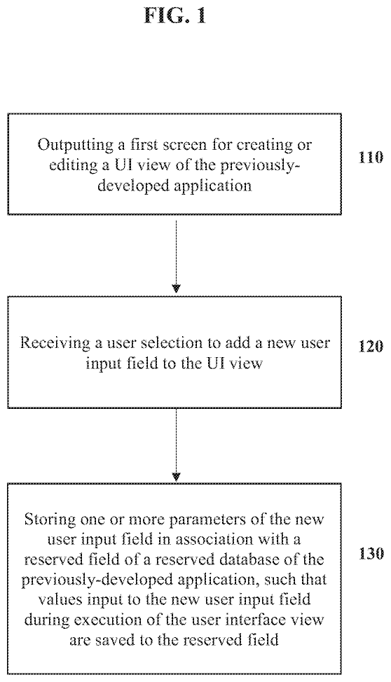

FIG. 1 is a flowchart of an example process for adding user-defined custom fields to a user interface (UI) view of a previously-developed application, according to an embodiment.

Referring to FIG. 1, at operation 110, a first screen for creating or editing a UI view of the previously-developed application is output for display. Here, the UI view corresponds to an execution view or page of the application through which a user may input values to user input fields, where said values are then stored in a database associated with the application. The UI view may correspond a particular resource entity from among a plurality of resource entities or levels (e.g., a site, a project/work order, a job, or a location)

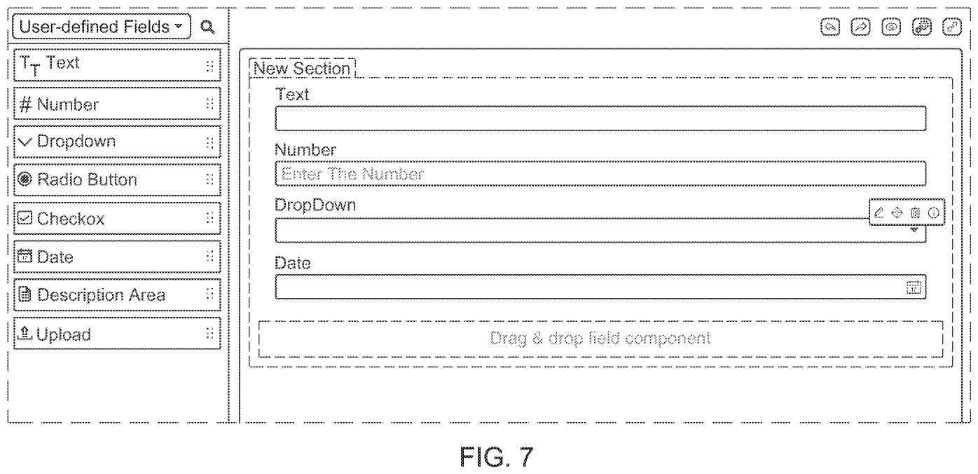

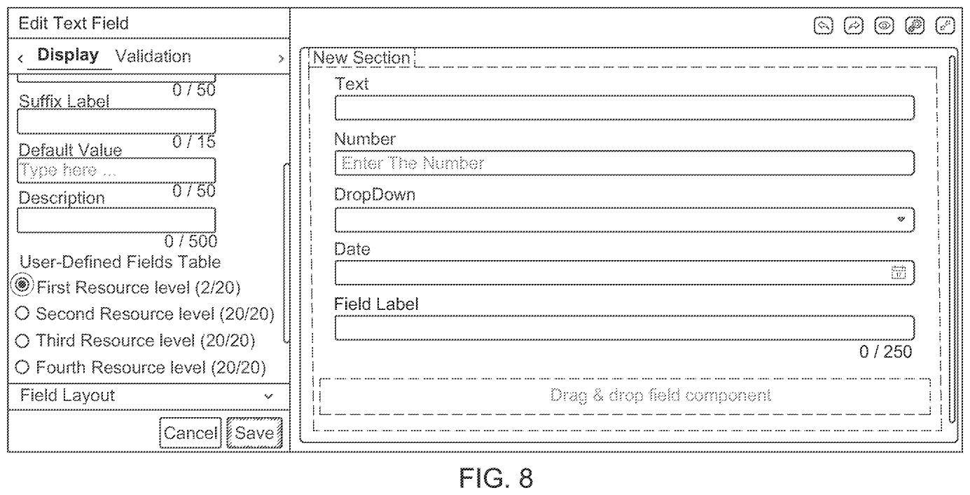

The first screen is a screen through which a user (or end user) can customize, add, edit, etc., a UI view for a particular use case, as shown by way of example in FIG. 7 and FIG. 8. That is, through the first screen, the user can add, define, remove, configure, etc., various user input fields to be included in the UI view. The first screen may be a screen that is part of the application (i.e., the application itself may include a tool for editing, customizing, adding, etc., UI views) or may be of a different application.

By way of example, the first screen may be output for display on a display unit of a client device or user terminal that accesses the application, such as through a web browser, over a network. According to another embodiment, the first screen may be displayed on a same device that stores and executes the application.

At operation 120, a user selection to add a new user input field to the UI view is received. The user selection to add a new user input field may include a user selection of a field type for the new user input field. The user selection may be from among a plurality of predetermined field types implemented into the application for use. For example, the predetermined field types may include a text field type, a number field type, and a date field type. The plurality of predetermined field types may also include a dropdown field type, a radio button field type, a checkbox field type, a description area field type, and an upload field type.

In an example embodiment, the received user input is in the form of a drag-and-drop input. A graphical user interface (GUI) object corresponding to the field type may be dragged from a list of the plurality of predetermined field types to an editable display area for defining user input fields of the UI view. An instance of the drag-and-drop GUI may be shown by way of example in FIG. 7.

Further, in operation 120, one or more user inputs defining one or more additional parameters (e.g., label, description, etc.) of the new user input field may also be received.

At operation 130, one or more parameters of the new user input field is stored in association with a reserved field of a reserved database of the previously-developed application, such that values input to the new user input field during execution of the user interface view are saved to the reserved field. At least one of the one or more parameters (e.g., field type) may be stored in a particular database (e.g., a customs fields detail table or database) that defines the parameter(s) of the new user input field at the application level (e.g., defining the reserved field as a text field type for all UI views that will include user input fields associated with that reserved field). Further, at least another of the one or more parameters (e.g., field label) may be stored at the view level. Accordingly, for one UI view, the new user input field associated with a reserved field may have a label (e.g., “Name”) and a field type (e.g., text field type), whereas for another UI view, the user input field associated with that reserved field may have a different label (e.g., “Gender”) but must have the same field type (i.e., text field type) because the field type is defined at the application level whereas the label is defined at the view level.

The previously-developed application may include a plurality of predefined user input fields predefined during application development, a corresponding plurality of predefined database fields mapped thereto, and the reserved database comprising a predetermined number of reserved fields for mapping to new user input fields added post-development. Thus, an end user may edit the application by defining new user input fields (or custom fields) on the fly, without having to request changes to the hard coding of the application from a development team. As a result, flexibility and user convenience increase, while time and financial costs decrease.

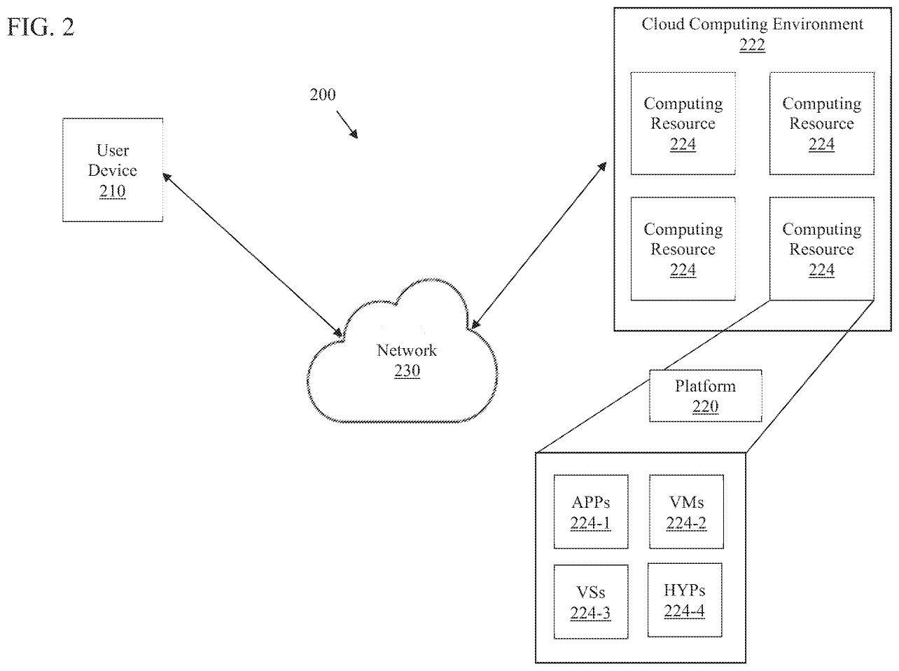

FIG. 2 is a diagram of an example environment 200 in which systems and/or methods, described herein, may be implemented. As shown in FIG. 2, environment 200 may include a user device 210, a platform 220, and a network 230. Devices of environment 200 may interconnect via wired connections, wireless connections, or a combination of wired and wireless connections. In embodiments, any of the functions of the elements included in network monitoring system 100 may be performed by any combination of elements illustrated in FIG. 2. For example, in embodiments, user device 210 may perform one or more functions associated with user device 106, and platform 220 may perform one or more functions associated with any of degradation trigger module 102, procedure identification module 104, correlation module 106, matching module 108, or new anomaly identification module 110.

User device 210 includes one or more devices capable of receiving, generating, storing, processing, and/or providing information associated with platform 220. For example, user device 210 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device. In some implementations, user device 210 may receive information from and/or transmit information to platform 220.

Platform 220 includes one or more devices capable of receiving, generating, storing, processing, and/or providing information. In some implementations, platform 220 may include a cloud server or a group of cloud servers. In some implementations, platform 220 may be designed to be modular such that certain software components may be swapped in or out depending on a particular need. As such, platform 220 may be easily and/or quickly reconfigured for different uses.

In some implementations, as shown, platform 220 may be hosted in cloud computing environment 222. Notably, while implementations described herein describe platform 220 as being hosted in cloud computing environment 222, in some implementations, platform 220 is not be cloud-based (i.e., may be implemented outside of a cloud computing environment) or may be partially cloud-based.

Cloud computing environment 222 includes an environment that hosts platform 220. Cloud computing environment 222 may provide computation, software, data access, storage, etc. services that do not require end-user (e.g., user device 210) knowledge of a physical location and configuration of system(s) and/or device(s) that hosts platform 220. As shown, cloud computing environment 222 may include a group of computing resources 224 (referred to collectively as “computing resources 224” and individually as “computing resource 224”).

Computing resource 224 includes one or more personal computers, a cluster of computing devices, workstation computers, server devices, or other types of computation and/or communication devices. In some implementations, computing resource 224 may host platform 220. The cloud resources may include compute instances executing in computing resource 224, storage devices provided in computing resource 224, data transfer devices provided by computing resource 224, etc. In some implementations, computing resource 224 may communicate with other computing resources 224 via wired connections, wireless connections, or a combination of wired and wireless connections.

As further shown in FIG. 2, computing resource 224 includes a group of cloud resources, such as one or more applications (“APPs”) 224-1, one or more virtual machines (“VMs”) 224-2, virtualized storage (“VSs”) 224-3, one or more hypervisors (“HYPs”) 224-4, or the like.

Application 224-1 includes one or more software applications that may be provided to or accessed by user device 210. Application 224-1 may eliminate a need to install and execute the software applications on user device 210. For example, application 224-1 may include software associated with platform 220 and/or any other software capable of being provided via cloud computing environment 222. In some implementations, one application 224-1 may send/receive information to/from one or more other applications 224-1, via virtual machine 224-2.

Virtual machine 224-2 includes a software implementation of a machine (e.g., a computer) that executes programs like a physical machine. Virtual machine 224-2 may be either a system virtual machine or a process virtual machine, depending upon use and degree of correspondence to any real machine by virtual machine 224-2. A system virtual machine may provide a complete system platform that supports execution of a complete operating system (“OS”). A process virtual machine may execute a single program, and may support a single process. In some implementations, virtual machine 224-2 may execute on behalf of a user (e.g., user device 210), and may manage infrastructure of cloud computing environment 222, such as data management, synchronization, or long-duration data transfers.

Virtualized storage 224-3 includes one or more storage systems and/or one or more devices that use virtualization techniques within the storage systems or devices of computing resource 224. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 224-4 may provide hardware virtualization techniques that allow multiple operating systems (e.g., “guest operating systems”) to execute concurrently on a host computer, such as computing resource 224. Hypervisor 224-4 may present a virtual operating platform to the guest operating systems, and may manage the execution of the guest operating systems. Multiple instances of a variety of operating systems may share virtualized hardware resources.

Network 230 includes one or more wired and/or wireless networks. For example, network 230 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

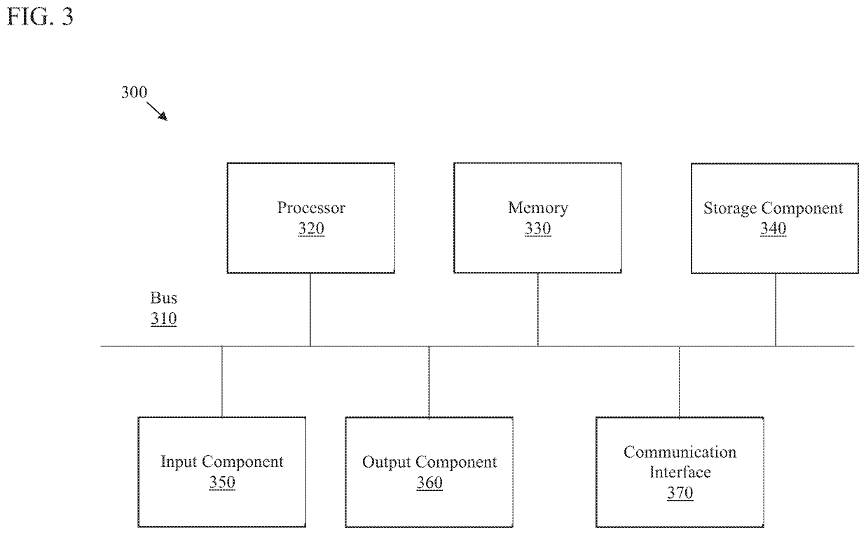

FIG. 3 is a diagram of example components of a device 300. Device 300 may correspond to user device 210 and/or platform 220. As shown in FIG. 3, device 300 may include a bus 310, a processor 320, a memory 330, a storage component 340, an input component 350, an output component 360, and a communication interface 370.

Bus 310 includes a component that permits communication among the components of device 300. Processor 320 may be implemented in hardware, firmware, or a combination of hardware and software. Processor 320 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 320 includes one or more processors capable of being programmed to perform a function. Memory 330 includes a random access memory (RAM), a read only memory (ROM), and/or another type of dynamic or static storage device (e.g., a flash memory, a magnetic memory, and/or an optical memory) that stores information and/or instructions for use by processor 320.

Storage component 340 stores information and/or software related to the operation and use of device 300. For example, storage component 340 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive. Input component 350 includes a component that permits device 300 to receive information, such as via user input (e.g., a touch screen display, a keyboard, a keypad, a mouse, a button, a switch, and/or a microphone). Additionally, or alternatively, input component 350 may include a sensor for sensing information (e.g., a global positioning system (GPS) component, an accelerometer, a gyroscope, and/or an actuator). Output component 360 includes a component that provides output information from device 300 (e.g., a display, a speaker, and/or one or more light-emitting diodes (LEDs)).

Communication interface 370 includes a transceiver-like component (e.g., a transceiver and/or a separate receiver and transmitter) that enables device 300 to communicate with other devices, such as via a wired connection, a wireless connection, or a combination of wired and wireless connections. Communication interface 370 may permit device 300 to receive information from another device and/or provide information to another device. For example, communication interface 370 may include an Ethernet interface, an optical interface, a coaxial interface, an infrared interface, a radio frequency (RF) interface, a universal serial bus (USB) interface, a Wi-Fi interface, a cellular network interface, or the like.

Device 300 may perform one or more processes described herein. Device 300 may perform these processes in response to processor 320 executing software instructions stored by a non-transitory computer-readable medium, such as memory 330 and/or storage component 340. A computer-readable medium is defined herein as a non-transitory memory device. A memory device includes memory space within a single physical storage device or memory space spread across multiple physical storage devices.

Software instructions may be read into memory 330 and/or storage component 340 from another computer-readable medium or from another device via communication interface 370. When executed, software instructions stored in memory 330 and/or storage component 340 may cause processor 320 to perform one or more processes described herein.

Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 3 are provided as an example. In practice, device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

In embodiments, any one of the operations or processes of FIG. 1 may be implemented by or using any one of the elements illustrated in FIGS. 2-3.

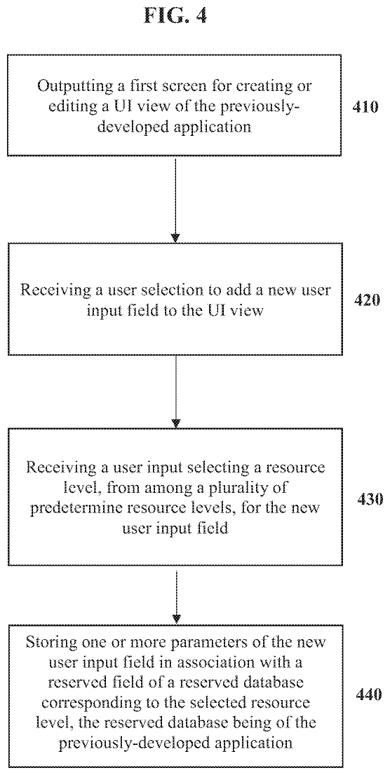

FIG. 4 is a flowchart of an example process for adding user-defined custom fields to a user interface (UI) view of a previously-developed application, according to an embodiment. Operations 410, 420, and 440 respectively correspond to operations 110, 120, and 130 and therefore redundant descriptions thereof may not be repeated below.

Referring to FIG. 4, at operation 430, a user input selecting a resource level, from among a plurality of predetermined resource levels, for the new user input field is received. The plurality of predetermined resource levels are implemented into the application at the development stage. The plurality of predetermined resource levels may correspond to different categories or applicable entities to which a UI view relates, and may be hierarchical. For example, the resource levels may be hierarchically arranged (from top-to-bottom) as Location->Site->Job->Work Order. In this case, inputs made with respect to a UI view at the Location resource level would be applicable to all (or one or more) Sites within that Location.

The application comprises a plurality of predetermined reserved databases respectively corresponding to the plurality of predetermined resource levels, each of the plurality of predetermined reserved databases comprising a predetermined number of reserved fields. The predetermined number of reserved fields are created or implemented at the development stage of the application. The predetermined number of reserved fields for the predetermined reserved database at a given resource level may be 20, as shown in TABLE 1.

TABLE 1
Predetermined Resource Level

| | | | | |
|---|---|---|---|---|
| Reserved | Reserved | Reserved | Reserved | Reserved |
| Field 1 | Field 2 | Field 3 | Field 4 | Field 5 |
| Reserved | Reserved | Reserved | Reserved | Reserved |
| Field 6 | Field 7 | Field 8 | Field 9 | Field 10 |
| Reserved | Reserved | Reserved | Reserved | Reserved |
| Field 11 | Field 12 | Field 13 | Field 14 | Field 15 |
| Reserved | Reserved | Reserved | Reserved | Reserved |
| Field 16 | Field 17 | Field 18 | Field 19 | Field 20 |

The creation of a new user field of a particular resource level is dependent or based upon the quantity of unoccupied reserved fields of the predetermined reserved database for that resource level. By way of example in TABLE 2 and TABLE 3, the predetermined database at a First Resource Level contains two occupied reserved fields (User Input Field 1 and User Input Field 2) and 18 unoccupied reserved fields, and the predetermined database at a Second Resource Level contains 20 occupied reserved fields and 0 unoccupied reserved fields.

TABLE 2
First Resource Level

| | | | | |
|---|---|---|---|---|
| User Input | User Input | Reserved | Reserved | Reserved |
| Field A1 | Field A2 | Field A3 | Field A4 | Field A5 |
| Reserved | Reserved | Reserved | Reserved | Reserved |
| Field A6 | Field A7 | Field A8 | Field A9 | Field A10 |
| Reserved | Reserved | Reserved | Reserved | Reserved |
| Field A11 | Field A12 | Field A13 | Field A14 | Field A15 |
| Reserved | Reserved | Reserved | Reserved | Reserved |
| Field A16 | Field A17 | Field A18 | Field A19 | Field A20 |

TABLE 3
Second Resource Level

| | | | | |
|---|---|---|---|---|
| User Input | User Input | User Input | User Input | User Input |
| Field B1 | Field B2 | Field B3 | Field B4 | Field B5 |
| User Input | User Input | User Input | User Input | User Input |
| Field B6 | Field B7 | Field B8 | Field B7 | Field B10 |
| User Input | User Input | User Input | User Input | User Input |
| Field B11 | Field B12 | Field B13 | Field B14 | Field B15 |
| User Input | User Input | User Input | User Input | User Input |
| Field B16 | Field B17 | Field B18 | Field B19 | Field B20 |

According to the above, an option to for a user to newly create a new user input field to First Resource Level would be available as there are 18 unoccupied reserved fields. In the case of Second Resource Level, all of the predetermined number of reserved fields are occupied and there is no option to newly create an additional new user input field.

In one or more embodiments, as described above, at least some of the parameters corresponding to a newly created user input field are stored at the view level. Thus, even though a user may not newly create a user input field at a resource level where all reserved fields are occupied, the user may still provide a new definition of view-level parameters for an existing user field that is associated with a (occupied) reserved field. Take, for example, a case in which a user previously created a user input field with a field type of text and a field label of “Name” for a first UI view. Upon saving, this new user input field was associated with an available reserved field of a reserved database corresponding to the First Resource Level at operation 440 of FIG. 4. In an embodiment, the field type may be an application level parameter and the field label may be a view level parameter. Thus, for a different UI view, the user may define a different label (among other view level parameters) for the user input field and associate it with the same reserved field at the First Resource Level.

The UI may display the quantity of occupied fields of the reserved fields per each resource level. For example, in FIG. 8, the UI displays wherein the First Resource Level has 2 occupied fields of the 20 reserved fields (2/20) and the Second Resource Level has 20 occupied fields of the 20 reserved fields (20/20).

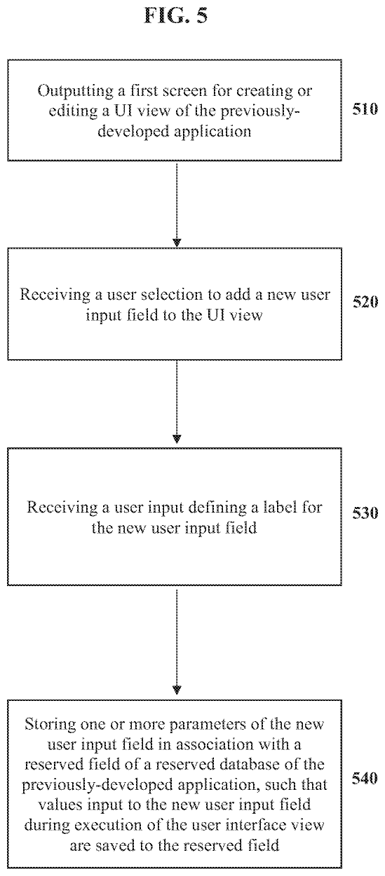

FIG. 5 is a flowchart of an example process for adding user-defined custom fields to a user interface (UI) view of a previously-developed application, according to an embodiment. Operations 510, 520, and 540 respectively correspond to operations 110, 120, and 130 and therefore redundant descriptions thereof may not be repeated below.

Referring to FIG. 5, at operation 530, a user input defining a label for the new use input field is received. A plurality of different parameters may be defined for the new user input field, including at least one of a label, a placeholder text, a suffix label, a default value, and a description.

According to an embodiment, the label may be saved in association with the new user input field at a view level, such that different labels may be defined for new user input fields in different views. The parameters of the custom field stored at the application level are fixed for the custom field across the application, while the parameters of the custom field stored at the view level are not fixed and can vary from one view to the next.

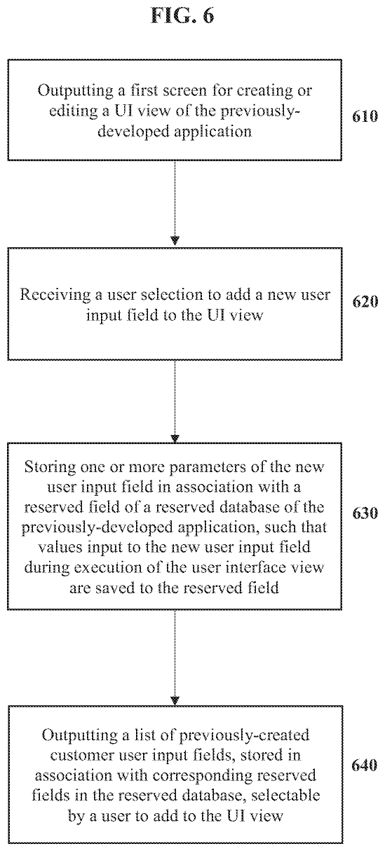

FIG. 6 is a flowchart of an example process for adding user-defined custom fields to a user interface (UI) view of a previously-developed application, according to an embodiment. Operations 610-630 respectively correspond to operations 110-130 and therefore redundant descriptions thereof may not be repeated below.

Referring to FIG. 6, at operation 640, a list of previously-created custom user input fields, stored in association with corresponding reserved fields in the reserved database, that are selectable by a user to add to the UI view is outputted.

The list of previously-created custom user input fields may be output at the resource level basis. For example, a first list may correspond to First Resource Level and a second list may correspond to Second Resource Level.

According to an embodiment, the list of previously-created custom user input fields may be divided into different sub-lists. For example, the list may be divided into predetermined fields predefined during application development and previously-created custom fields. It is understood that operation 640 may be performed prior to operation 630.

Further, it is understood that, for each of the flowcharts described above, one or more operations may be omitted, one or more operations may be added, and/or an order of one or more operations may vary.

The foregoing disclosure provides illustration and description, but is not intended to be exhaustive or to limit the implementations to the precise form disclosed. Modifications and variations are possible in light of the above disclosure or may be acquired from practice of the implementations.

Some embodiments may relate to a system, a method, and/or a computer readable medium at any possible technical detail level of integration. Further, one or more of the above components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a module, segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code-it being understood that software and hardware may be designed to implement the systems and/or methods based on the description herein.

What is claimed is:

1. A method, performed by at least one processor, for adding user-defined custom fields to a user interface (UI) view of a previously-developed application, the method comprising:
outputting a first screen for creating or editing a UI view of the previously-developed application;
receiving a user selection to add a new user input field to the UI view; and
storing one or more parameters of the new user input field in association with a reserved field of a reserved database of the previously-developed application, such that values input to the new user input field during execution of the user interface view are saved to the reserved field,
wherein the previously-developed application comprises a plurality of predefined user input fields predefined during application development, a corresponding plurality of predefined database fields mapped thereto, and the reserved database comprising a predetermined number of reserved fields for mapping to new user input fields added post-development.

2. The method according to claim 1, wherein the receiving the user selection to add a new user input field to the UI view comprises receiving a user input of a field type, from among a plurality of predetermined field types, for the new user input field.

3. The method according to claim 2, wherein the plurality of predetermined field types comprises a text field type, a number field type, a dropdown field type, and a radio button field type.

4. The method according to claim 2, wherein the received user input is a drag-and-drop user input in which a graphical user interface (GUI) object corresponding to the field type is dragged from a list of the plurality of predetermined filed types to an editable display area for defining user input fields of the UI view.

5. The method according to claim 2, wherein the stored one or more parameters comprises the field type, and the stored one or more parameters are stored in association with the reserved field at an application level.

6. The method according to claim 1, further comprising:
receiving a user input selecting a resource level, from among a plurality of predetermined resource levels, for the new user input field,
wherein the application comprises a plurality of predetermined reserved databases respectively corresponding to the plurality of predetermined resource levels, each of the plurality of predetermined reserved databases comprising a predetermined number of reserved fields.

7. The method according to claim 1, further comprising:
receiving a user input defining a label for the new user input field,
wherein the label is saved in association with the new user input field at a view level, such that different labels may be defined for the new user input field in different views.

8. The method according to claim 1, further comprising outputting a list of previously-created customer user input fields, stored in association with corresponding reserved fields in the reserved database, selectable by a user to add to the UI view.

9. An apparatus for adding user-defined custom fields to a user interface (UI) view of a previously-developed application, the apparatus comprising:
a memory storing instructions; and
at least one processor configured to execute the instructions to:
output a first screen for creating or editing a UI view of the previously-developed application;
receive a user selection to add a new user input field to the UI view; and
store one or more parameters of the new user input field in association with a reserved field of a reserved database of the previously-developed application, such that values input to the new user input field during execution of the user interface view are saved to the reserved field,
wherein the previously-developed application comprises a plurality of predefined user input fields predefined during application development, a corresponding plurality of predefined database fields mapped thereto, and the reserved database comprising a predetermined number of reserved fields for mapping to new user input fields added post-development.

10. The apparatus according to claim 9, wherein the at least one processor is further configured to execute the instructions to receive a user input of a field type, from among a plurality of predetermined field types, for the new user input field.

11. The apparatus according to claim 10, wherein the plurality of predetermined field types comprises a text field type, a number field type, a dropdown field type, and a radio button field type.

12. The apparatus according to claim 10, wherein the received user input is a drag-and-drop user input in which a graphical user interface (GUI) object corresponding to the field type is dragged from a list of the plurality of predetermined filed types to an editable display area for defining user input fields of the UI view.

13. The apparatus according to claim 10, wherein the stored one or more parameters comprises the field type, and the stored one or more parameters are stored in association with the reserved field at an application level.

14. The apparatus according to claim 9, wherein the at least one processor is further configured to execute the instructions to:
receive a user input selecting a resource level, from among a plurality of predetermined resource levels, for the new user input field,
wherein the application comprises a plurality of predetermined reserved databases respectively corresponding to the plurality of predetermined resource levels, each of the plurality of predetermined reserved databases comprising a predetermined number of reserved fields.

15. The apparatus according to claim 9, wherein the at least one processor is further configured to execute the instructions to:
receive a user input defining a label for the new user input field,
wherein the label is saved in association with the new user input field at a view level, such that different labels may be defined for the new user input field in different views.

16. The apparatus according to claim 9, wherein the at least one processor is further configured to execute the instructions to output a list of previously-created customer user input fields, stored in association with corresponding reserved fields in the reserved database, selectable by a user to add to the UI view.

17. A non-transitory computer-readable recording medium having recoded thereon instructions executable by at least one processor to perform a method for adding user-defined custom fields to a user interface (UI) view of a previously-developed application, the method comprising:
outputting a first screen for creating or editing a UI view of the previously-developed application;
receiving a user selection to add a new user input field to the UI view; and
storing one or more parameters of the new user input field in association with a reserved field of a reserved database of the previously-developed application, such that values input to the new user input field during execution of the user interface view are saved to the reserved field,
wherein the previously-developed application comprises a plurality of predefined user input fields predefined during application development, a corresponding plurality of predefined database fields mapped thereto, and the reserved database comprising a predetermined number of reserved fields for mapping to new user input fields added post-development.

18. The non-transitory computer-readable recording medium according to claim 17, wherein the receiving the user selection to add a new user input field to the UI view comprises receiving a user input of a field type, from among a plurality of predetermined field types, for the new user input field.

19. The non-transitory computer-readable recording medium according to claim 18, wherein the plurality of predetermined field types comprises a text field type, a number field type, a dropdown field type, and a radio button field type.

20. The non-transitory computer-readable medium according to claim 18, wherein the received user input is a drag-and-drop user input in which a graphical user interface (GUI) object corresponding to the field type is dragged from a list of the plurality of predetermined filed types to an editable display area for defining user input fields of the UI view.
